(19) United States
(12) Patent Application Publication
(10) Pub. No.: US 2018/0024557 A1
(43) Pub. Date: Jan. 25, 2018

(54) AUTONOMOUS SYSTEM FOR TAKING MOVING IMAGES, COMPRISING A DRONE AND A GROUND STATION, AND ASSOCIATED METHOD

(71) Applicant: PARROT DRONES, Paris (FR)

(72) Inventor: Edouard LEURENT, Paris (FR)

(21) Appl. No.: 15/657,143

(22) Filed: Jul. 22, 2017

(30) Foreign Application Priority Data
Jul. 22, 2016 (FR) 1657016

(51) Int. Cl. G05D 1/00; G03B 17/56; B64C 39/02; H04N 7/18; B64D 47/08; H04N 5/232; G03B 15/00

(52) U.S. Cl. CPC G05D 1/0094; H04N 5/23238; G03B 17/561; G03B 15/006; H04N 7/185; G05D 1/0011; B64D 47/08; B64C 39/024; G06F 3/04842

(57) ABSTRACT

The displacements of the drone are defined by piloting commands applied to a set of propulsion units of the drone, the drone flying along a trajectory that is at least in part predetermined, to take moving images of a target. The drone adjusts the camera sight angle during its displacements, and as the case may be, those of the target, so that at each instant, the image taken by the camera contain the position of the target. The system comprises means for determining a static trajectory of the drone for the shooting, means for determining a dynamics of displacement of the drone along the static trajectory, and means for generating flying instructions for the drone based on the two determinations and on information about the target position over time.

### CROSS REFERENCE TO RELATED APPLICATIONS

This application claims priority under 35 U.S.C. § 119(a) to French Patent Application Serial Number 1657016, filed Jul. 22, 2016, the entire teachings of which are incorporated herein by reference.

### BACKGROUND OF THE INVENTION

### Field of the Invention

The invention relates to remote-piloted flying motorized devices, hereinafter generally called “drones”.

### Description of the Related Art

The invention specifically applies to rotary-wing drones, such as quadricopters, a typical example of which is the Bebop of Parrot SA, Paris, France, which is a drone equipped with a series of sensors (accelerometers, three-axis gyrometers, altimeter), a front camera capturing an image of the scene towards which the drone is directed, and a vertical-view camera capturing an image of the overflown terrain.

But the invention may apply as well to other types of drones, for example fixed-wing drones, in particular of the “flying wing” type such as, for example, the eBee model of SenseFly, Cheseaux-Lausanne, Switzerland, which is a professional land-mapping drone, or the Disco model recently presented by Parrot SA, Paris, France.

Rotary-wing drones are provided with multiple rotors driven by respective motors able to be controlled in a differentiated manner in order to pilot the drone in attitude and speed.

The documents WO 2010/061099 A2 and EP 2 364 757 A1 (Parrot SA) describe such a drone as well as the principle of piloting thereof by means of a terminal such as a touchscreen multimedia telephone or player with an integrated accelerometer, for example a cellular phone of the iPhone type or a multimedia tablet of the iPad type (registered trademarks). These devices incorporate the various control elements required for the detection of the piloting commands and the bidirectional exchange of data via a radio link of the Wi-Fi (IEEE 802.11) or Bluetooth wireless local network type. They are further provided with a touch screen displaying the image captured by the front camera of the drone, with in superimposition a number of symbols allowing the activation of commands by simple contact of the operator's finger on this touch screen.

The front video camera of the drone may be used to capture sequences of images of a scene towards which the drone is directed. The user can hence use the drone in the same way as a camera or a camcorder that, instead of being held in hand, would be borne by the drone. The images collected can be recorded then broadcast, put online on video sequence hosting web sites, sent to other Internet users, shared on social networks, etc.

The front camera is advantageously a steerable camera, in order to direct in a controlled manner in a predetermined direction the sight axis, and hence the field of the images transmitted with the video stream. A technique implemented in particular in the abovementioned Bebop device and described in the EP 2 933 775 A1 consists is using a high-definition wide-angle camera provided with a hemispherical-field lens of the fisheye type covering a field of about 180° and in windowing in real time the raw image delivered by this sensor, by a software processing ensuring the selection of the useful pixels of the raw image in a determined capture zone as a function of a certain number of parameters, including commands of pointing towards a particular target chosen by the user or automatically followed by the drone. As a variant, or even as a complement, of the control of the camera sight axis by a windowing software program, it is also possible to mount the camera on a three-axis articulated support of the gimbal type with Cardan suspension, provided with servomotors piloted as a function of the gyrometer data and of the pointing commands The invention applies of course to any type of camera, steerable or not, and whatever is the pointing mode thereof.

In a so-called “tracking” mode, the drone can be programmed to follow a mobile target whose coordinate are known and so that, during the flight, the sight axis of the camera is directed towards said target. This target is typically the terminal itself, carried by a user who may be in motion (for example, practicing a sport in which he moves—running, sliding, driving, etc.). In this mode, the drone is capable of filming the evolutions of the user without the latter has to act on the displacements of the drone and on the sight axis of the camera.

For that purpose, the coordinates of the terminal, obtained by a GPS unit equipping the latter in a manner known per se, are communicated to the drone by the wireless link, and the drone can hence adjust its displacements so as to follow the terminal and so that the sight axis of the camera remains directed towards the terminal.

This functionality is already known in certain products of the market, for example from the FR 3 031 402 A1 (also published as US 2016/194079 A1), which proposes to pre-program trajectories around the target and to allow the user to choose one of them in a “camera-movements library” for the automatic piloting of the drone in the tracking mode.

The US 9 164 506 B1 illustrates in a detailed manner a technique of target tracking by a drone, in particular a drone provided with a camera mounted on a steerable cradle.

But the shooting possibilities offered by these devices remain very limited in terms of trajectories the drone can travel along during the filming, and in terms of the way the drone travels along this trajectory.

For example, in the above-mentioned FR 3 031 402 A1, no indication is given on the way to travel along the pre-programmed trajectory, under the control of the user who would desire to influence the speed of displacement of the drone along the selected (static) trajectory, in such a manner to be able to accelerate/slow down the displacement, to immobilise the drone at a certain point, to cause it to travel along the trajectory in the reverse direction, etc.

### BRIEF SUMMARY OF THE INVENTION

The basic idea of the invention consists, to compensate for these limitations, in separating the generation of the trajectories (choice of a bell-shaped trajectory, a circular trajectory, etc.) from the manner the drone will travel along these trajectories.

The object of the invention is to propose to the user widened possibilities of taking moving images of a target that is potentially in motion, and to better control the displacements of the drone during these shootings.

The matter is, for example, for a bell-shaped curve, to avoid a slowing down at the apex of the parabola and a more and more high speed at the bottom of the latter, when the drone comes closer to the target.

According to a first aspect, the invention proposes for that purpose a system for taking moving images, comprising a drone provided with a camera, and a ground station communicating with the drone through a wireless link, the displacements of the drone being defined by piloting commands applied to a propulsion unit or a set of propulsion units of the drone. The drone is adapted to fly along a trajectory that is at least in part predetermined, to take moving images of a target, and to adjust the camera sight angle during the displacements of the drone, and as the case may be, of the target, so that at each instant, the image taken by the camera contain the position of the target.

Characteristically of the invention, the system comprises means for determining a static trajectory of the drone with respect to the target for the shooting, means for determining a dynamics of displacement of the drone along the static trajectory, and means for generating, based on the two determinations and on information about the target position over time, flying instructions for the drone.

According to various advantageous subsidiary characteristics:

means for determining a static trajectory of the drone comprise means associated with a user interface of the ground station for selecting a trajectory among a set of memorized trajectories;

the means for determining a static trajectory of the drone comprise means associated with a user interface for making the adjustment of at least one parameter of the selected trajectory;

the memorized trajectories to be selected comprise at least two trajectories chosen in the following group: the bell-shaped trajectories, the closed-curve trajectories, the helix trajectories, the zoom trajectories;

the system comprises means for adjusting on the determined trajectory a shoot beginning position and a shoot end position;

the means for determining a dynamics of displacement comprise a user interface allowing determining an evolution of speed along the static trajectory;

the determination of the evolution of speed comprises the determination of points of arrest of the drone;

the determination of the evolution of speed comprises the determination of a speed reversal of the drone.

The camera may be a wide-angle fixed camera of the fisheye type, and it is then provided means for adjusting said camera sight angle, adapted to frame and process the wide-angle images taken by the camera, or a camera mounted on a three-axis articulated support of the gimbal type with Cardan suspension, provided with servomotors, and the means for adjusting said camera sight angle are means adapted to pilot said servomotors.

According to a second aspect of the invention, it is proposed a ground station adapted to communicate through a wireless link with a drone provided with a camera, to send it piloting commands so as for it to fly along a trajectory that is at least in part predetermined, for taking moving images of a target. The station is characterized in that it comprises means for determining a static trajectory of the drone with respect to the target for the shooting, means for determining a dynamics of displacement of the drone along the static trajectory, and means for generating, based on the two determinations and on information about the target position over time, flying instructions for the drone.

It is further proposed, according to a third aspect of the invention, a method for determining a trajectory the drone must travel along for taking moving images of a target, as the case may be in motion, characterized in that it comprises the following steps:

selecting a static trajectory the drone must travel along with respect to the target;

determining a dynamics of displacement of the drone along this static trajectory;

generating, based on the selected static trajectory, the determined dynamics and the coordinates of the target, flying instructions for the drone.

### BRIEF DESCRIPTION OF THE SEVERAL VIEWS OF THE DRAWINGS

An exemplary embodiment of the drone according to the invention will now be described, with reference to the appended drawings in which the same references denote identical or functionally similar elements throughout the figures.

FIG. 1 is a schematic overall view of a shooting system comprising a drone and a ground station.

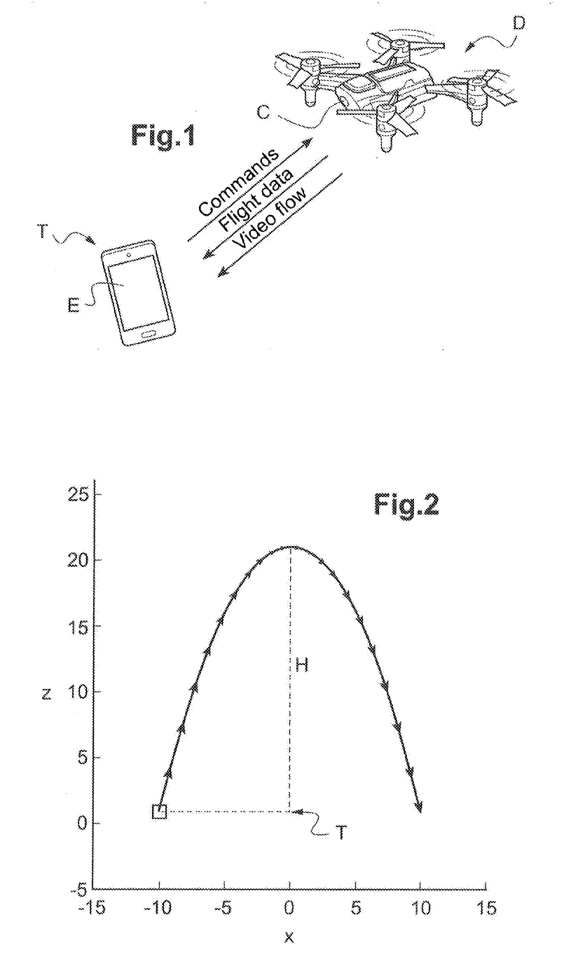

FIG. 2 illustrates an example of trajectory of the drone for taking moving images of a target.

FIG. 3 is a block diagram of a set of functional units for the trajectory determination according to the invention.

FIG. 4 is a block diagram of a set of functional units for the generation of piloting commands and the control of the sight axis of the camera of the drone.

FIGS. 5A-5E illustrate a set of typical static trajectories for the drone.

### DETAILED DESCRIPTION OF THE INVENTION

An exemplary embodiment of the invention will now be described.

It applies to a drone, for example a drone of the quadricopter type such as the Parrot Bebop Drone, various technical aspects of which are described in above-mentioned EP 2 364 757 A1, EP 2 613 213 A1, EP 2 450 862 A1 or EP 2 613 214 A1.

The drone D includes coplanar rotors whose motors are piloted independently by an integrated navigation and attitude control system. It is provided with a front-view camera C allowing obtaining an image of the scene towards which the drone is directed.

The drone may also preferably include a second, vertical-view camera (not shown), pointing downward, adapted to capture successive images of the overflown terrain and used in particular to evaluate the speed of the drone relative to the ground.

Inertial sensors (accelerometers and gyrometers) allow measuring with a certain accuracy the angular speeds and the attitude angles of the drone, i.e. the Euler angles (pitch, roll and yaw) describing the inclination of the drone with respect to a horizontal plane of a fixed terrestrial reference system, it being understood that the two longitudinal and transverse components of the horizontal speed are intimately linked to the inclination following the two respective pitch and roll axes. An ultrasonic range finder arranged under the drone moreover provides a measurement of the altitude with respect to the ground. The drone is also provided with location means allowing determining its absolute position in space, in particular based on data coming from a GPS receiver, or by other means, for example by integration of the measurements produced by the sensors of the inertial unit.

The camera C is preferably a hemispheric-field fixed camera of the fisheye type, as described for example in the EP 2 933 775 A1 (Parrot). With such a camera, the changes of the camera sight axis are not made by physical displacement of the camera, but by framing and processing the images taken by the camera as a function of a virtual sight angle, determined with respect to the main axis of the drone, given as a set-point.

The drone D is piloted by a ground station T, typically in the form of a remote-control device, for example of the model aircraft remote-control type, a smartphone or a smart tablet. The smartphone or the smart tablet are provided with a touch screen E displaying the image inside the front camera C, with, in superimposition, a certain number of symbols allowing the activation of piloting commands by simple contact of a user's finger on the touch screen E. When the drone D is piloted by a station T of the remote-control type, the user may be provided with immersive piloting glasses, often called FPV (“First Person View”) glasses. The device T is also provided with means for radio link with the drone D, for example of the WiFi (IEEE 802.11) local network type, for the bidirectional exchange of data from the drone D to the device T, in particular for the transmission of the image captured by the camera C and of flight data, and from the device T to the drone D for the sending of piloting commands

According to the invention, the system consisted by the drone D and the device T is configured so that the drone is provided with the ability to autonomously follow and film a target, typically the target consisted by the device T itself carried by the user, offering the user the possibility to trigger automatic trajectories to easily produce interesting and aesthetical shots.

These shots are defined by three-dimensional trajectories recomputed in real time with respect to the position of the user.

Advantageously, the user may trigger the animation by a simple pressure on a button of the touch screen of the terminal T, the drone executing the displacements while keeping the subject carrying the terminal centred in the video.

According to one aspect of the invention, the system separates i) the static definition of the shape of the 3D curve representing the trajectory adopted by the drone D from ii) the manner this curve is travelled along over time.

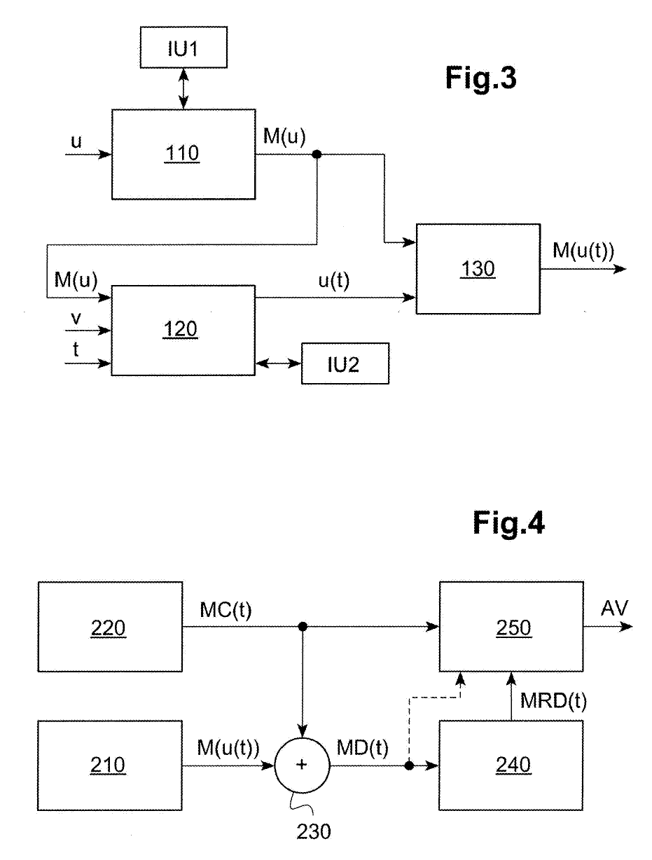

With reference now to FIG. 2, the generation of a particular trajectory for taking moving images centred to the target will be explained in more details.

In the example taken herein only by way of illustration, the shape of the trajectory of the drone is that of a bell-shaped curve C: the drone films the target by travelling along a parabola passing just above the target (herein the user, who carries the device T) to arrive on the other side.

This trajectory could, in a first approach, be defined simply by the parametric equation of a parabola, i.e.:

X(t)=t i.

Z(t)=H−(t−t0)² ii.

But if this curve is described over time, it is understood that the speeds of displacement are significant at the beginning and at the end, and that the drone will slow down at the apex of the parabola. This is explained by the fact that the way the shape of the curve is expressed is intimately linked to the way it is described over time (herein, a constant speed along axis X).

According to the invention, the system is arranged so as to allow the user to control the course of the animation by being able to influence the speed of displacement of the drone along the chosen trajectory, so as to be able to accelerate the displacement, to slow it down, to immobilize the drone during a certain time, or even to cause it to travel along the trajectory in the reverse direction.

For that purpose, an electronic piloting architecture is used, preferably a software architecture, which allows separating the generation of the trajectories from the generation of the manner the drone will move along these trajectories.

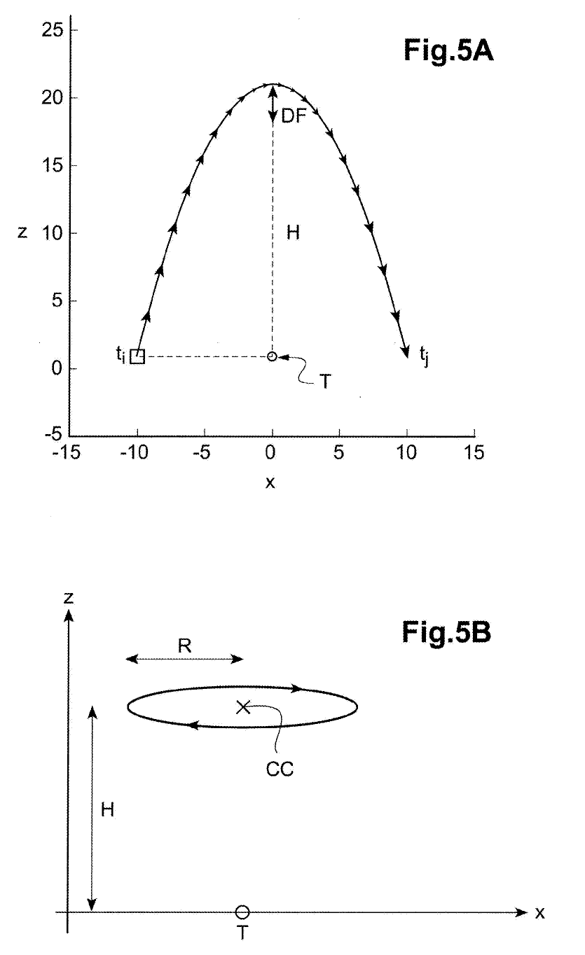

With reference to FIG. 3, the block 110 has for object to describe the shape of the trajectory, i.e. of the curve in the three-dimensional space the drone will travel along, independently of any dynamics. This trajectory is described by a parameterized curve:

M(u)=(x(u), y(u), z(u))

with a beginning at u=u0 and an end at u=u1.

In the present example, the trajectory is described with respect to origin O(0,0,0), which represents the position of terminal T carried by the user.

In the present example of a parabola, we have:

x(u)=(1−2u).x0 i.

y(u)=(1−2u).y0 ii.

z(u)=4*u*(u−1).H+z0 iii.

with u0=0, u1=1 and M0(x0,y0,z0) the position of the drone with respect to the user at the launching of the animation.

Still with reference to FIG. 3, the block 120 has for object, once the shape of the trajectory defined, to define at each instant the speed of displacement of the drone along this trajectory. The block 120 receives as an input the desired speed v, which can:

either depend on the progression of the trajectory, for example to slow down at the beginning and at the end:

v=v(u)=v(u(t))

or be redefined at each instant, for example by a programming of the user, i.e.:

v=v(t)

The block 120 also receives as an input the curve M(u) and the time t. Based on the parameters M(u), v and t, the block 120 determines the evolution of the parameter u as a function of time, by the following steps:

computing the gradient of the trajectory at the current position:

g=dM/du(u)

computing the desired curvilinear speed v=v(t) or v=v(u(t)); and

determining the increment of the parameter u corresponding to a time increment dt, i.e.:

u(t+dt)=u(t)+v*dt/∥g∥

It will be noted herein that, in the cases where the trajectory is not properly defined and comprises singularities, the gradient may be null. The notion of speed hence makes no sense because M(t) is not differentiable at this instant. The parameter u is hence incremented by a small variation du to exit from the singularity, i.e.:

u(t+dt)=u(t)+du

where du is fixed and very small relative to |u1-u0|.

Hence, at the exit of the block 120 is obtained the evolution of the parameter u as a function of time t.

It is hence possible to generate the drone position set-point at each instant by computing M(u(t)). This computation is performed by the block 130 of FIG. 3.

The so-generated trajectory then verifies the following properties:

M(t)=M(u(t)): the trajectory is compliant with the desired shape;

at any time, the desired speed is respected: ∥dM/dt∥=|v(t)|;

u(t) is strictly increasing and varies from u0 to u1 within a finite time if v(t)>vmin>0; and

u(t) is strictly decreasing and reaches the start value u0 within a finite time if v(t)<vmin<0.

One the static trajectory defined and the dynamics of this trajectory taken into account as described hereinabove, the system determines the position the drone D must adopt by taking also into account the position of the target herein consisted of the terminal T that moves with the user. It also determines the camera sight axis set-point.

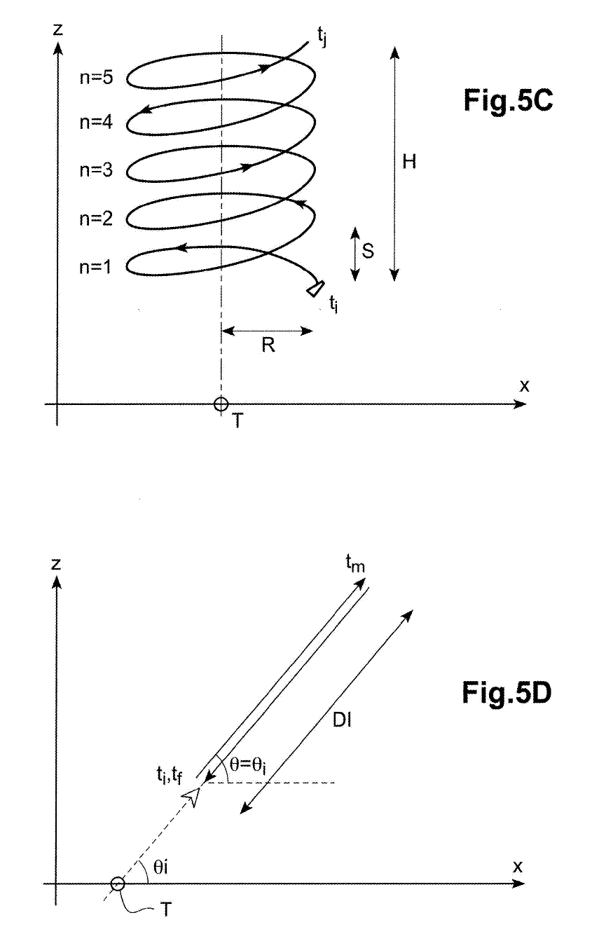

FIG. 4 illustrates as a block diagram the whole processing operations implemented.

The block 210 corresponds to all the blocks 110 to 130 of FIG. 3 and provides the coordinates of the dynamic trajectory M(u(t)).

The block 220 provides the coordinates MC(t) of the target, coming preferably from a GPS unit of the terminal T itself constituting the target.

The summer 230 determines the coordinate set-points for the drone D, denoted MD(t), by summing the coordinates MC(t) and the trajectory coordinates M(u(t)).

These coordinate set-points are applied to the piloting system of the drone (block 240) so that it follows these set-points.

Moreover, the coordinates of the target MC(t) and the coordinates of the real position of the drone (MRD(t)), following the set-points MD(t) (or directly the set-point MD(t)) are applied at the inputs of a block 250, whose role is to define the coordinates of the sight axis of the camera C of the drone in order to generate images centred to the target, herein to the user carrying the terminal T.

The determination of this axis is performed, in a basic embodiment, by a subtraction between the coordinates of the target and the coordinates of the drone.

In a preferred embodiment, the block 110 accedes to a memory in which are stored a set of static trajectories, and the terminal T is provided with a user interface IU1, preferably a touch interface, allowing choosing one of the trajectories before the flight. Preferably, this interface IU1 also allows adjusting certain parameters of the trajectory (see examples of trajectories, and their parameters, in the following).

The blocs 120 is functionally connected to a user interface IU2 allowing adjusting the dynamics of the travel along the selected trajectory at the block 110.

Many possibilities may be contemplated for this adjustment:

a certain number of buttons with predefined options (constant speed, speed varying randomly about a mean, increasing or decreasing speed, with, as the case may be, points of zero speed, etc.);

a touch interface on which the static trajectory is displayed and on which the user can, by means of his finger, adjust the speed zone by zone, define points of arrest and of return, etc.

The two above-mentioned options may of course be combined together.

It will be noted herein that the processing operations illustrated in FIGS. 3 and 4 are herein implemented by a central processing unit equipping the terminal T. In embodiment variants, all or part of these processing operations may be implemented in a central processing unit on-board the drone D. The user interfaces IU1 and IU2 are generated at the touch screen E of the terminal, the link with the respective blocks 110 and 120 is hence performed either within the terminal T, or via the wireless link between the terminal and the drone in the case where the corresponding processing operations are executed in the drone.

In still other variants, the above-mentioned processing operations may be operated within a remote cloud server with which the drone is registered. The latter is then provided, in addition to the WiFi communication module through which it exchanges data with the terminal T, with another communication module allowing it to connect directly to a 3G or 4G mobile phone network. It is then possible to transfer to this cloud server a certain number of piloting operations and computations, of image processing, etc. instead of executing them in a processor on-board the drone or the remote-control terminal.

Moreover, the sequence of images taken by the camera C of the drone D during the traveling thereof can be either stored in a memory on-board the drone then transferred towards the terminal or another smart device at the end of the flight, or streamed during the shooting itself, and stored in the terminal T, or also transferred to a cloud server in the hypothesis indicated hereinabove.

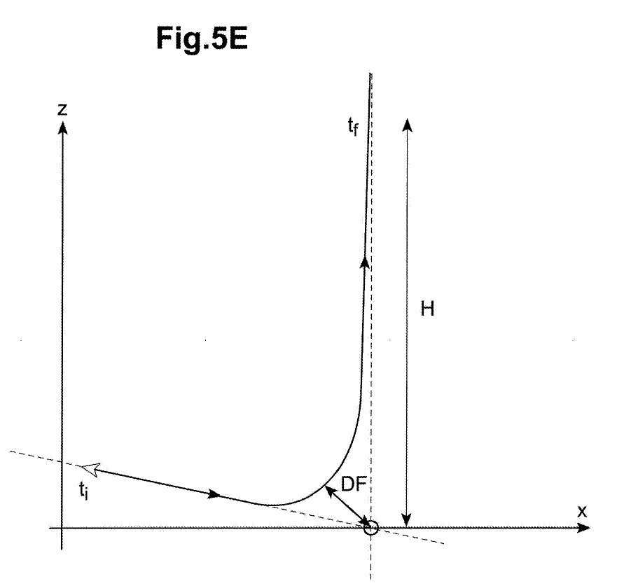

A certain number of possible examples of static trajectories has been illustrated in FIGS. 5A to 5E:

“bell-shaped” displacement along a parabola (FIG. 5A, see also FIG. 2): the drone goes up, passes above the target T, and goes back down to interrupt the sequence at the point symmetrical to the start point; it is possible to vary the focal length (DF) parameter of the parabola (more or less wide parabola), and to adjust the positions t, and h of beginning and end of filming, themselves determining the height (H) of the trajectory; it is also possible to provide a displacement over a portion of a circle or of any other curve contained in a vertical plane;

circle of constant altitude (FIG. 5B): the drone travels along a circle whose centre (CC) is just above the target T; it is possible to vary the parameters of altitude (H), radius (R) of the circle and start and end positions; it may also be contemplated a circle contained in an inclined plane or any other curved closed on itself or not such as an ellipse, etc.;

ascending or descending helix (FIG. 5C): the drone travels along one or several circles, while moving up by a given height; it is possible to vary the pitch (S) of the helix, its radius (R), the direction of its axis and the number of turns to travel through, which itself determines, in combination with the pitch, the total variation of height (H) of the trajectory; it is also possible to vary the radius as a function of the height, to obtain a helix inscribed in a cone;

“boomerang-type” displacement (FIG. 5D), with a first travel along an oblique line and a return along the same line; the drone performs a movement causing a zoom-out shooting by moving away from the target over a distance DI, then comes back to its start point to perform a zoom-in: the target T may be in the continuation of the line, or elsewhere; moreover, it is possible to vary the angle (θ) of the line and the length (DI) thereof; as a variant, it is possible to provide a curved trajectory;

“zoom” displacement (FIG. 5E), on a trajectory typically of the hyperbolic-type: the drone flies towards the target, then its trajectory bends near the target and it moves up to place vertically above the target; it is possible to vary the parameters of inclination of the two asymptotes, the focal length (DF) determining a more or less abrupt change of direction, and the sequence start and end positions tᵢ and t_{f} (see in particular the sequence end position t_{f} corresponding to an altitude H); moreover, the target can be on the second asymptote, or not.

What is claimed is:

1. A system for taking moving images, comprising:
a drone provided with a camera;
a ground station communicating with the drone through a wireless link, the displacements of the drone being defined by piloting commands applied to a propulsion unit or a set of propulsion units of the drone, the drone being adapted to fly along a trajectory that is at least in part predetermined, to take moving images of a target, and to adjust the sight angle of the camera during the displacements of the drone, and as the case may be, of the target, so that at each instant, the image taken by the camera contain the position of the target;
a drone management module comprising program code enabled upon execution to perform:
determining a static trajectory of the drone with respect to the target for the shooting;
determining a dynamics of displacement of the drone along the static trajectory; and
generating flying instructions for the drone based on the two determinations and on information about the target position over time.

2. The system according to claim 1, wherein determining a static trajectory of the drone comprise selecting in association with a user interface of the ground station, a trajectory among a set of memorized trajectories.

3. The system according to claim 2, wherein determining a static trajectory of the drone comprise making in association with the user interface the adjustment of at least one parameter of the selected trajectory.

4. The system according to claim 2, wherein the memorized trajectories comprise at least two trajectories selected from the group consisting of:
bell-shaped trajectories, closed-curve trajectories, helix trajectories, and zoom trajectories.

5. The system according to claim 1, wherein the program code further adjusts on the determined trajectory a shoot beginning position and a shoot end position.

6. The system according to claim 1, wherein determining a dynamics of displacement of the drone along the static trajectory comprises determining in a user interface an evolution of speed along the static trajectory.

7. The system according to claim 6, wherein the determination of the evolution of the speed comprises the determination of points of arrest of the drone.

8. The system according to claim 6, wherein the determination of the evolution of the speed comprises the determination of a speed reversal of the drone.

9. The system according to claim 1, wherein the camera is a wide-angle fixed camera of the fisheye type, and adjusts said camera sight angle, adapted to frame and process the wide-angle images taken by the camera.

10. The system according to claim 1, wherein the camera is a camera mounted on a three-axis articulated support of a gimbal type with Cardan suspension, provided with servomotors, and adjusts said camera sight angle, adapted to pilot said servomotors

11. A ground station, adapted to communicate through a wireless link with a drone provided with a camera, to send the drone piloting commands so as for the drone to fly along a trajectory that is at least in part predetermined, for taking moving images of a target, the station comprising:
a processor and memory; and,
a drone management module comprising program code enabled upon execution by the processor in the memory to perform:
determining a static trajectory of the drone with respect to the target for the shooting;
determining a dynamics of displacement of the drone along the static trajectory; and
generating flying instructions for the drone based on the two determinations and on information about the target position over time.

12. A method for determining a trajectory that a drone must travel along for taking moving images of a target comprising the steps of:
selecting a static trajectory the drone must travel along with respect to the target;
determining a dynamics of displacement of the drone along this static trajectory; and
generating flying instructions for the drone based on the selected static trajectory, the determined dynamics and the coordinates of the target.
